(19) United States
(12) Patent Application Publication
(10) Pub. No.: US 2014/0312263 A1
(43) Pub. Date: Oct. 23, 2014

(54) ADVANCED THERMAL PROPERTIES OF A SUSPENSION WITH GRAPHENE NANO-PLATELETS (GNPS) AND CUSTOM FUNCTIONALIZED F-GNPS

(71) Applicant: UCHICAGO ARGONNE, LLC, Chicago, IL (US)

(72) Inventors: Elena V. Timofeeva, Chicago, IL (US); Dileep Singh, Naperville, IL (US)

(73) Assignee: UCHICAGO ARGONNE, LLC, Chicago, IL (US)

(21) Appl. No.: 14/257,775

(22) Filed: Apr. 21, 2014

Related U.S. Application Data
(60) Provisional application No. 61/814,546, filed on Apr. 22, 2013.

(51) Int. Cl. C09K 5/20

(52) U.S. Cl. CPC C09K 5/20
USPC 252/74; 252/73

(57) ABSTRACT

A method for producing nanofluids with multilayered graphene nanoplatelets for providing improved heat transfer coolant fluids. A method for optimizing the concentration of nanoplatelets based on their morphology that allows achieving high thermal conductivity and low viscosity thus resulting in high heat transfer coefficient. A method is provided to functionalize as received graphene nanoplatelets by oxidaitively treating the multilayered graphene/nanothin graphite to generate highly dispensable nanoparticles for suspension in polar fluids for cooling thermal sources, such as power electronics and other heat transfer cooling applications.

### CROSS-REFERENCE TO RELATED APPLICATIONS

This application claims priority to U.S. Provisional Application No. 61/814,546 filed Apr. 22, 2013, which is incorporated by reference herein in its entirety.

### STATEMENT OF GOVERNMENT INTEREST

The United States Government claims certain rights in this invention pursuant to Contract No. W-31-109-ENG-38 between the United States Government and the University of Chicago and/or pursuant to DE-ACO2-06-CH11357 between the United States Government and UChicago Argonne, LLC representing Argonne National Laboratory.

### FIELD OF INVENTION

This invention relates generally to heat transfer fluids. More particularly, the invention relates to fluid suspensions having advanced thermal properties using graphene nanoplatelets and customized functionalized graphene nanoplatelets disposed in water and ethylene glycol/water mixtures.

### BACKGROUND OF THE INVENTION

This section is intended to provide a background or context to the invention that is, inter alia, recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

In the area of heat transfer fluids, nanofluids or suspensions with nanoparticles generally refers to a liquid mixture with a small concentration of nanometer-sized (about 1 to 100 nm in at least one dimension) solid particles in suspension. Nanoparticles are typically made of chemically stable metals, metal oxides or carbon. Some combinations of nanoparticles and liquids have been shown to substantially increase the heat transfer characteristics of the nanofluid over the base liquid.

Nanofluid heat transfer is a relatively new field and has been focused on determining the levels of potential thermal conductivity and heat transfer enhancement of a variety of nanofluids. In these investigations, the emphasis was usually on the magnitude of the thermal phenomena and not on the viability of the fluids for commercial applications. The thermal conductivity of nanofluids in particular has received considerable attention by researchers. Thermal conductivity is easier to measure than the heat transfer coefficient and has been used as an indicator of nanofluid heat transfer enhancement.

Enhancements in the thermal conductivities of nanofluids, for the most part, follow the predictions based on Maxwell's mean field theory assuming low concentrations and spherical nanoparticles or the effective medium theory (EMT). For small nanoparticles concentrations, EMT predicts thermal conductivity enhancement as (k_{nf}/k_{bf})≈1+3φ, where k_{nf} and k_{bf} are thermal conductivities of the nanofluid and the fraction. However, there are instances where the actual enhancements are significantly higher than EMT predictions at very low concentrations of nanoparticles. These anomalous enhancements have been reported for metallic nanoparticles in fluids. Modest thermal conductivity enhancements over EMT predictions can also be achieved by modifying the shape of the nanoparticles.

Thermal conduction in nanofluids has been attributed to a variety of mechanisms, including Brownian motion interactions between the nanoparticles and the fluid, clustering and agglomeration. There is no clear consensus on a specific mechanism; however, the general belief is that a combination of mechanisms may be operating and would be specific to a nanoparticles/fluid system and test conditions. Further, the effect of interface layers on the nanoparticles on thermal conductivity is not clearly understood. A metal particle with surface oxidation, for example, is believed to continuously increase the interfacial resistance and consequently reduce the thermal conductivity.

Experimental results from various nanofluid research efforts have considered a number of parameters, including without limitation; (1) particle volume concentration, (2) particle material, (3) particle size, (4) particle shape, (5) base fluid, (6) temperature, (7) additive, and (8) pH. These studies have shown heat transfer enhancement results, based on Nusselt number, to be generally in the 15-40% range for particle volume concentrations up to 4%. Some research has found that the heat transfer enhancement was close to or somewhat above predictions from standard liquid heat transfer correlations using the nanofluid properties. Nusselt number enhancement of 40% is attractive to many applications, if the nanofluid is commercially viable.

However, studies of thermal phenomena in nanofluids have generally failed to make detailed characterizations of the fluids. For instance, it is known that particle agglomeration may occur in many nanofluids so that the nominal particle size in a powder is often not the size in the suspension. In fact, particle size distributions often exist in nanofluids but are seldom measured. As a result, literature data based on nominal particle size, may in fact have involved significantly different average particle sizes and distributions in suspension.

One particular area of application for nanofluids is in the field of power electronics, which is a critical component of hybrid electronic vehicles (HEVs) and electric vehicles (EVs) since it provides control and conversion of electric power. Increasing power loads result in increased heat fluxes, thus uninterrupted operation of power electronics requires liquid cooling systems to enhance heat dissipation, improve energy efficiency, and lengthen device lifetime. In current hybrid electric vehicles, two cooling systems are used: a higher temperature system for cooling the gasoline engine and a lower temperature system for cooling the power electronics. An important commercial goal is to eliminate the lower temperature system and to accomplish all cooling with a single higher temperature system. This would obviously reduce weight (thereby increasing fuel economy) and also reduce complexities.

In recent work a heat transfer analysis for a typical heat exchanger has been performed to determine the magnitude for enhancement in the thermal properties of a heat transfer fluid required to improve the cooling. Calculations have shown that for a designated heat exchanger (laminar flow) that an enhancement in thermal conductivity of between 50% and 100% could, without a significant increase in pumping power, allow either elimination of one radiator in HEVs or an increase in the loading. To satisfy these thermal management needs, the heat transfer efficiency of conventional fluids must be improved.

As noted hereinbefore, previous studies of nanofluids have demonstrated that such level of enhancement in thermal conductivity can be achieved with addition of metallic nanoparticles. Production of metal containing nanofluids faces some major challenges, such as stability towards agglomeration and surface oxidation, availability, cost of materials and manufacturing issues. In addition other work has shown nanofluids with commercially available graphitic nanoparticles of high aspect ratio and can provide a 100-200% increases in thermal conductivity for nanofluids with carbon nanotubes and graphene oxides. Such dramatic increases in thermal conductivity of nanofluids are most likely due to the unique nature of such highly anisotropic carbon nanomaterials that allows engaging multiple heat transfer mechanisms in suspensions (arising from the effective medium theory, percolation, and plasmon resonances). The drawback of carbonaceous nanofluids with high aspect ratio particles is very high viscosity (up to 3 orders of magnitude higher than viscosity of the base fluid). Such viscosity increases result in pumping power penalties that are much higher than the benefits in thermal conductivity of suspensions. Thus, the practical value of previously reported carbonaceous nanofluids is not sufficient for commercialization of the technology.

### SUMMARY OF INVENTION

Industrial applications for nanofluid technology are in an embryonic state. However, today, the nanofluid field has developed to the point where it is appropriate to look to the next level, i.e., nanofluids that show substantial heat transfer enhancement over their base fluids and are candidates for use in a variety of industrial/commercial systems. For example, potential use of nanofluids for cooling systems such as power electronics and also for radiators in vehicles, will require not only enhanced thermal properties, but also minimal negative mechanical effects of the nanofluids in a closed system. In this regard, reduced viscosity of the nanofluid for instance is a contributing factor to reducing pumping power needed for the circulation of the nanofluid.

Further, any erosive and clogging effects of the nanofluids on the fluids transmission lines can have an adverse effect on its use. Various nanofluids that may find widespread acceptance for industrial use should preferably be, at a minimum, stable suspensions with little or no particle settling, available in large quantities at affordable cost, environmentally neutral, and non-toxic. In addition, such applications would generally prefer that there be little change in particle agglomeration over time and that the nanofluids not be susceptible to adverse surface adhesion.

Nanofluids comprised of multilayered graphene nano-platelets (GnPs) and custom functionalized graphene nano-platelets (fGnPs) were disposed in various fluids, including, but not limited to, water and ethylene glycol/water mixtures. The advantage of the fGnPs can also be realized in other polar cooling fluids, such as other glycols (propylene glycol,diethylene glycol, triethylene glycol, etc., and their mixtures with other glycols or water, glycerin. GnP could benefit oils and other non-polar cooling fluids. Some of these nanofluids also can include a surfactant additive to stabilize particle suspensions. Because thermal conductivity of surfactants is very poor compared to water, often more preferred water-based nanofluids were comprised of functionalized GnPs wherein as received GnPs were treated by oxidation, such as by mixing with concentrated sulfuric and nitric acids. Such oxidized, or functionalized, GnPs were disposed in fluids without need of surfactants to achieve greatly improved thermal properties for the nanofluids. Such functionalized GnPs had dramatic changes of surface chemistry and distribution in fluid over the as received GnP, having particles which are hydrophilic and well dispersed. Scanning electron microscopy (SEM) of the dried droplet of f-GnP show platelets lying substantially flat on the silicon support as compared to the as received GnPs which are disposed in compact clusters on a support surface.

These and other advantages and features of the invention, together with the organization and manner of operation thereof, will become apparent from the following detailed description when taken in conjunction with the accompanying drawings, wherein like elements have like numerals throughout the several drawings prescribed below.

### BRIEF DESCRIPTION OF THE DRAWINGS

FIG. 1a illustrates an SEM image of an as received grade C-750 GnP; FIG. 1b illustrates an SEM image of an as received grade M-5 GnP; and FIG. 1c illustrates an SEM image of an as received grade H-5 GnP;

FIG. 2a illustrates thermal conductivity enhancement for four test nanofluids in 1 vol % of C-750 nanoparticles dispersed in deionized water, specimens treated as indicated; FIG. 2b shows the morphology of an as received GnP; FIG. 2c shows the morphology of GnP plus a surfactant; and FIG. 2d shows the morphology of GnP functionalized as described by Example I;

FIG. 3a shows an as received C-750 GnP; FIG. 3b shows a functionalized form of the C-750 GnP of FIG. 3a; FIG. 3c shows an as received M-5 GnP; and FIG. 3d shows a functionalized form of the M-5 GnP of FIG. 3c;

FIG. 4a shows Raman spectra of an as received GnP grade C-750 (lower plot) and a functionalized form of the C-750 GnP (upper plot); FIG. 4b shows Raman spectra of an as received GnP, grade M-5 (lower plot) and a functionalized form of the M-5 GnP (upper plot); FIG. 4c shows Raman spectra of an as received GnP, grade H-5 (lower plot) and a functionalized form of the H-5 GnP (upper plot).

FIG. 5 shows Zeta potential of M-5 grade unmodified GnP (squares) and functionalized GnP (circles) nanoparticles in EG/H₂O as a function of suspension pH;

FIG. 6a shows increase in thermal conductivity of graphitic nanofluids with unmodified GnP and functionalized GnP nanoparticles of 5 wt. % concentration measured at room temperature; and FIG. 6b shows viscosity of 5 wt. % M-5 grade GnP dispersions of unmodified, or as received GnP (diamonds) and functionalized GnP (circles) compared to the viscosity of the base fluid (squares);

FIG. 7a shows thermal conductivity increase as a function of particle concentration for three grades of functionalized GnP; and FIG. 7b shows viscosity as a function of temperature for various wt. % for functionalized GnP for all three grades;

FIG. 8a shows a schematic of electrostatic stabilization of core/shell graphite/graphene oxide nanoplatelets; and FIG. 8b shows pictorially a percolation threshold for nanoplatelets which allow for percolation and thermal conductivity mechanisms but creates minimal obstruction for fluid flow by allowing rotational motion of each of the nanoparticles; and

FIG. 9 illustrates calculated ratios of heat transfer coefficients for 5 wt. %. M-5 functionalized GnP in EG/H20 and base fluid EG/H20 in laminar and turbulent flow regimes.

### DETAILED DESCRIPTION OF PREFERRED EMBODIMENTS

In the embodiment GnPs were used as a starting point for functionalization to provide highly advantageous nanoparticles for dispersion in fluids, thereby creating a nanofluid of required performance and surprising characteristics.

In preparing preferred forms of the invention the carbon nanomaterials used are xGnP® brand (GnP), obtained from XG Sciences, Inc. These nanoparticles can be described as multilayered graphene nanoplatelets or nanothin graphite chips with various diameters and thicknesses. The multilayered GnPs have anistropic thermal conductivity with ˜2000 W/mK along the hexagonal carbon layers and only ˜10W/mK perpendicular to the layered graphite structure. Three example grades of GnPs were investigated, namely C-750, M-5 and H-5 that according to manufacturer's information are varied in thickness as ˜1-5 nm, 5-8 nm and 11-15 nm and surface areas of 750 m²/g, 120-150 m²/g and 60-80 m²/g, respectively.

GnP manufacturing processes are non-oxidizing, thus producing a pristine graphitic surface of sp² carbon molecules with minor oxidation at edges. Thus, as received GnP nanomaterials are highly hydrophobic, i.e., suspensions of GnPs in water and water/ethylene glycol mixtures require use of surfactants.

In this one embodiment, GnP nanoparticles of C-750 grade were disposed in deionized water base fluids. In one embodiment a series of tests, 1 wt. % of cationic (Cetyl Trimethyl Ammonium Bromide, CTAB by Acros Organics) and anionic (Sodium Dodecyl Sulfate, SDS by Acros Organics) surfactants in water were used as a base fluids. Stability and thermal conductivity of suspensions was compared to GnP dispersed without any surfactant and surface functionalized GnP prepared by a method described below.

In a second embodiment “functionalizing” the GnP material was accomplished by use with hydrophilic groups which then enable making those nanoparticle miscible with water, ethylene glycol, propylene glycol, glycerin and their mixtures. The functionalization procedure involved oxidation of as-received GnP powder and further detail is described in Example I hereinafter.

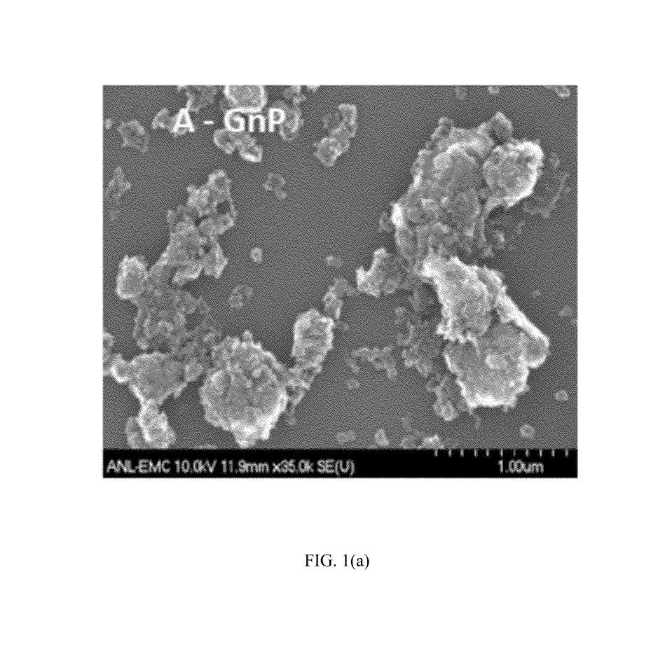

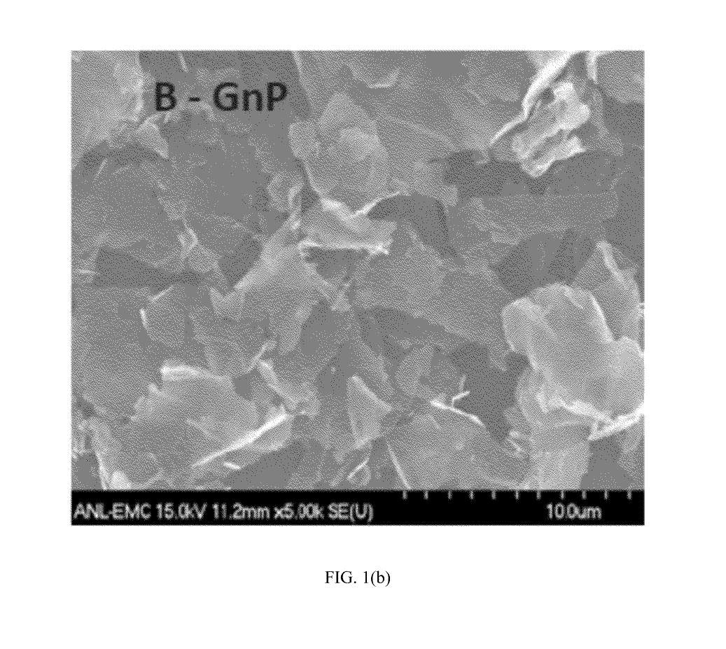

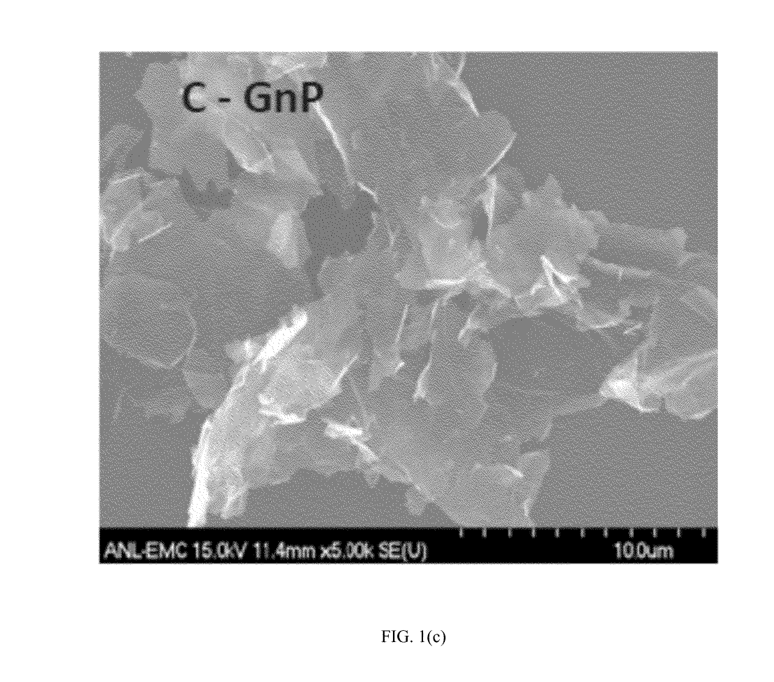

The morphology of the GnP nanoparticles before and after functionalization can be considered by comparison of various SEM images. Electron microscopy images of as-received GnP powders are shown in FIGS. 1a-1c. The difference in platelet thickness is not obvious from the image resolution, but there is a clear difference in platelet diameters. All GnP nanoparticles have irregular shape with particle diameters varying from 0.1-1 microns in C-750 grade, from 1-10 microns in M-5 grade and 3-25 microns in H-5 grade. As-received GnPs assemble into compact clusters on a Si wafer surface, especially C-750 grade, which is indicative of the hydrophobic nature of platelets.

In the case of the nanoparticles subjected to the surface functionalization process of Example I (controlled oxidation), studies were performed with SEM, Raman spectroscopy and compared to unmodified GnPs of the same grade. Essentially the process of Example I is an oxidation of the GnP powder in a mixture of concentrated sulfuric and nitric acids (3:1 ratio) that converts sp² graphite layers on the surface into OH⁻, COO⁻ and CO groups. These groups create sufficient electrostatic charge at the nanoplatelet surfaces that keeps the particles separated from each other due to repulsion and prevents particle agglomeration and settling. Thus good stability of graphitic nanofluids in a water or ethylene glycol/water base fluid mixtures can be achieved.

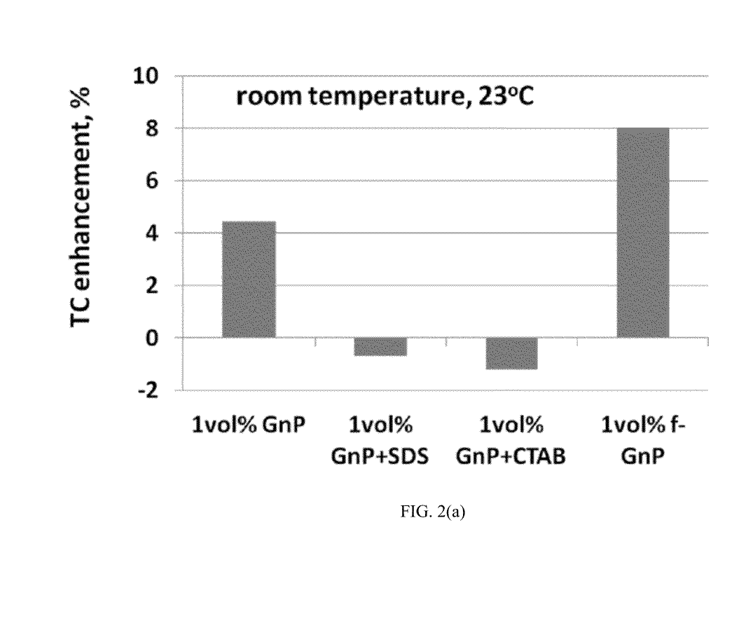

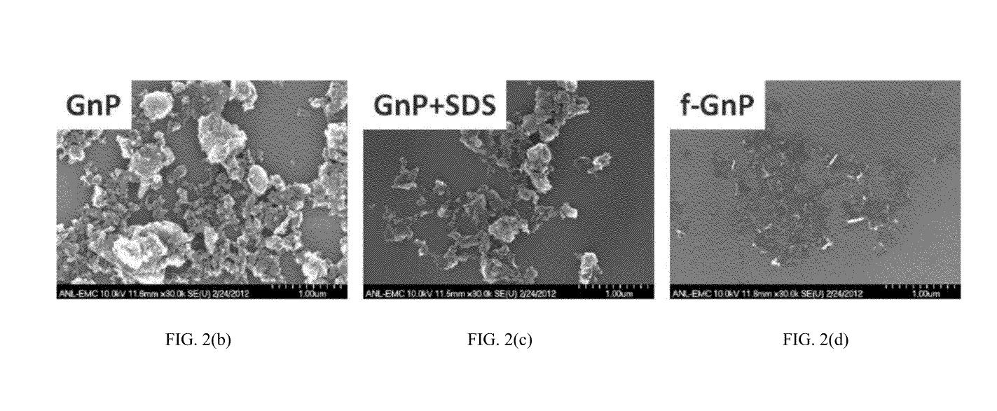

As received GnP graphitic nanopowders have very poor suspension stability in water, especially at low concentrations. The manufacturer suggests using a surfactant to improve dispersions of graphitic nanopowders in aqueous solutions. A series of tests were conducted that investigated the effect of cationic and anionic surfactants on thermal conductivity and stability of suspensions with C-750 grade GnP nanoparticles in deionized water. An alternative way of getting stable dispersions of graphitic nanoparticles by surface modification of carbon surfaces with hydrophilic groups was also tested and resulting nanofluids were compared to the suspensions stabilized with surfactants (see FIGS. 2a and 2d).

Suspensions with unmodified GnPs settle within a few hours, but initial reading of thermal conductivity show enhancements slightly above the effective medium theory predictions. Suspensions stabilized with cationic (CTAB) or anionic (SDS) surfactants show similar improvement in stability; however, thermal conductivity of those suspensions is below the base fluid due to very low thermal conductivity of organic molecules compared to water. In addition, segregation of surfactants at liquid/nanoparticle interface creates additional thermal resistance for heat flow. Thus organic surfactants are detrimental for the thermal conductivity of water-based suspensions. Use on non-surfactant approach to stabilizing dispersions of nanoparticles involves an additional surface functionalization step as described hereinafter. The resulting dispersion of C-750 f-GnP nanoparticles in water has superior stability even compared to suspensions stabilized by surfactants, and also showed improved thermal conductivity values. The SEM images of FIGS. 2b-2d show that a surfactant only slightly breaks granular agglomerated nanoplatelets, while surface functionalization clearly separates GnPs to individual nanoplatelets. Therefore, the surface functionalization method was a highly preferred method for preparing stable nanofluids from all grades of GnP nanoparticles.

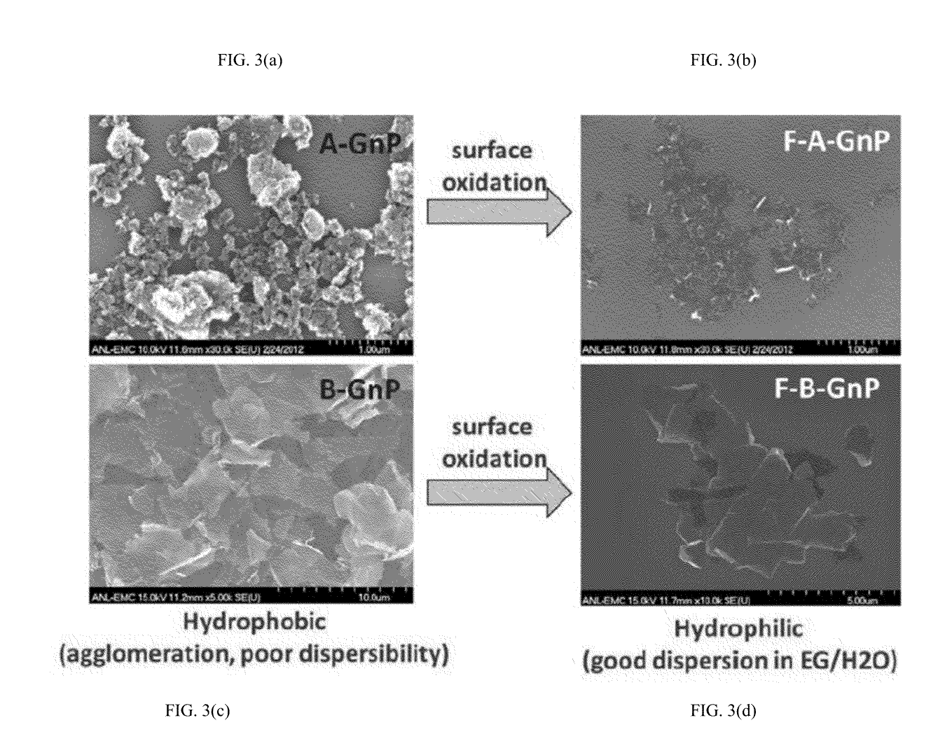

SEM images of a comparison of as received and f-GnPs (see FIGS. 3a-3d) show a dramatic change in morphological appearance of nanoparticles before and after the functionalization process. The f-GnPs are very well distributed on the surface of Si wafer with individual nanoplatelets lying flat, compared to granular agglomeration and clustering of unmodified nanoparticles depicted on FIG. 1. This is a clear sign of the hydrophilic nature of the nanoparticle surface that also helps in stabilization of f-GnP suspensions.

Raman spectroscopy is most sensitive to highly symmetric covalent bonds with little or no natural dipole moment. The carbon-carbon bonds fit this criterion perfectly and as a result, Raman spectroscopy is highly sensitive to changes in chemistry and morphology of carbon nanomaterials and able to provide a wealth of information about their structure. The graphite phase has several bands in the spectrum with the main band at 1582 cm−1 corresponding to sp² bonded carbon in planar sheets, also known as the G band. The band at ˜2700 cm−1, which is known as the 2D or G′ band, is much more intense in graphene compared to graphite. Widening and shifts of the peak that are typically observed in graphite samples are a result from interactions between the stacked graphene layers. The band at 1620 cm−1 and the shoulders on the 1582 cm−1 band are indicative of surface defect modes of sp² bonded carbon. A band around 1350 cm−1 known as the D band originates from a hybridized vibrational mode associated with graphene edges; and it indicates the presence of some disorder to the graphene structure; and its intensity relative to that of the G band is often used as a measure of the quality of graphitic nanomaterials. Finally the very broad band around 500 cm−1 is indicative of some amorphous sp³ bonded carbon. Raman spectra were taken of GnP nanomaterials before and after the surface functionalization. The information obtained in this series of tests is used in correlation to thermal properties of nanofluids.

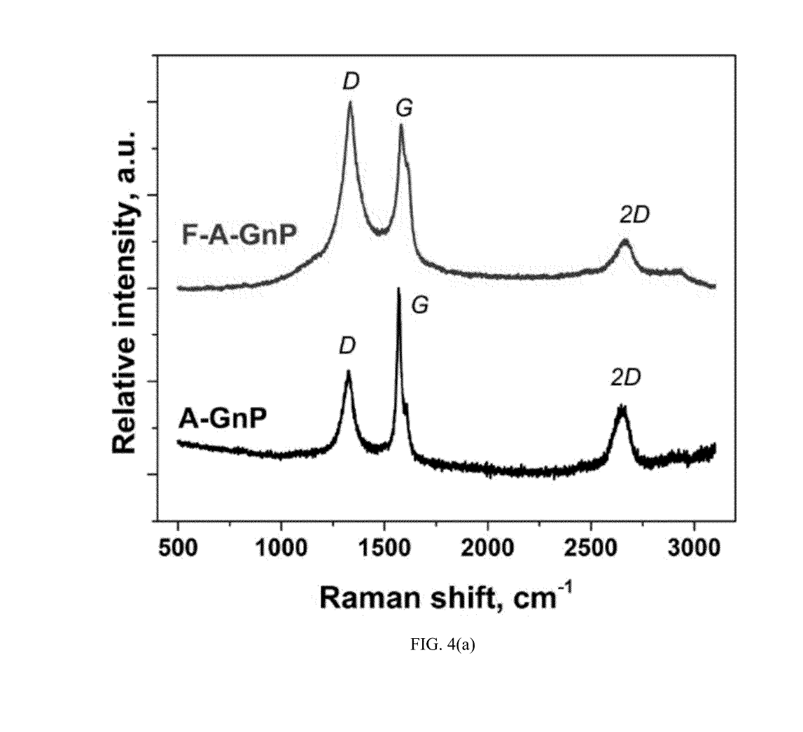

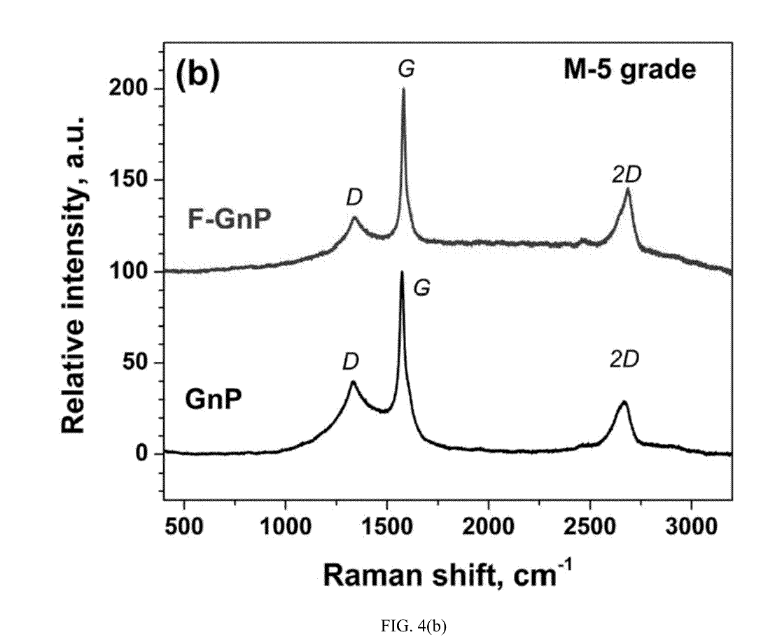

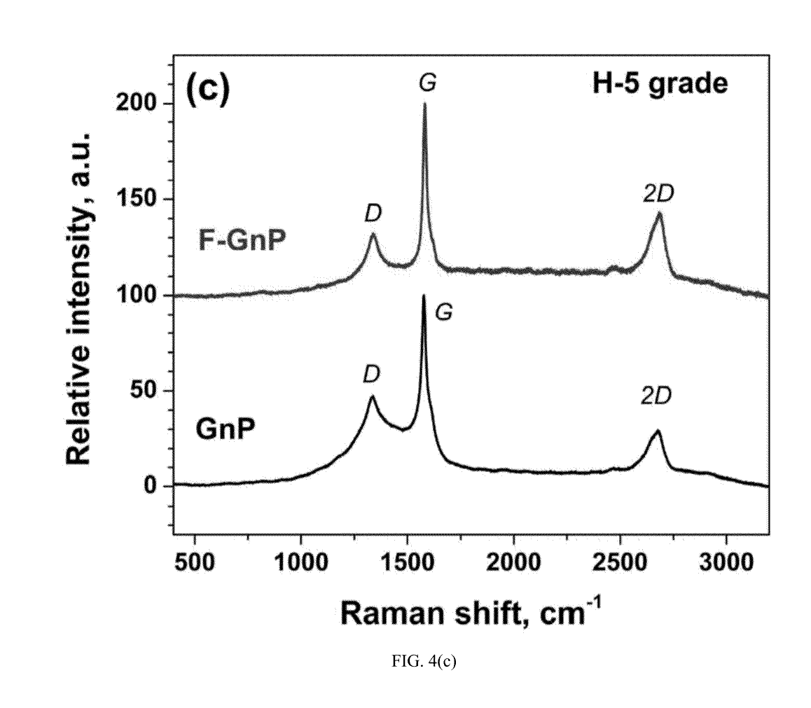

Because nanoparticle oxidation occurs only at the surface of nanoparticles, f-GnPs essentially represent a core-shell structure with graphitic core and graphene oxide shell. The thickness of the platelets and the total surface area of nanoparticles will affect the change that is observed in Raman spectra with functionalization. FIG. 4a shows changes in the Raman spectra of the smallest nanoplatelets. The change is very well pronounced: an increased intensity of D band, a lower intensity of the G band and a pronounced shoulder at ˜1620cm−1, all of which indicate a higher degree of disorder and increase in defect concentration in f-GnPs. On the other hand the intensity of the 2D peak has decreased in f-GnPs which (without limiting the scope of the invention) may indicate fewer interacting graphite layers in nanoplatelets (platelet thinning)

Analysis of M-5 and H-5 grades is shown in FIGS. 4b and 4c. The larger particles have less dramatic changes in the Raman spectra because of the smaller surface area and thicker graphite layers, and thus contribution of surface is less. Observations are in agreement with surface oxidation of GnP platelets (although not limiting the scope of the invention). The ratio of oxide/graphite can be critical for efficient thermal conductivity enhancements, i.e. surface area and morphology of nanoplatelets can be optimized for further improvement of heat transfer performance. The correlations between Raman spectra of nanoparticles and thermo-physical properties of nanofluids could allow better control of the nanofluid properties.

Zeta potential was also characterized for specimens since it can be related to stability of suspensions. Zeta potential is defined as electric potential in the interfacial double layer at the location of the slipping plane versus a point in the bulk fluid away from the interface. The higher the value of the zeta potential the higher is electrostatic repulsion between nanoparticles and therefore providing stability of dispersion. When the potential is low, attraction between particles exceeds repulsion resulting in agglomeration and settling of nanoparticles. On one hand the zeta potential is indication of nanoparticles surface chemistry, while on the other hand it changes with ionic composition of bulk solution. For water-based systems adjusting pH of solution could be used for controlling stability of suspensions. Investigations have been done of zeta potential as a function of pH in diluted suspension of unmodified GnP and f-GnP in EG/H₂O for M-5 grade (see FIG. 5). The results clearly demonstrate that f-GnP nanoparticles have 10 mV higher zeta potential than GnPs due to higher concentration of surface groups, and thereby resulting in higher stability of f-GnP suspensions. At pH between 7 and 9, the zeta potential values for f-GnP suspensions are more than about 40 mV which is considered as a threshold for good stability of suspensions. High zeta potential minimizes agglomeration of nanoparticles, and also results in lower viscosity of nanofluids for the same particle concentration. Thus, for the optimized heat transfer performance pH of GnP-EG/H₂O nanofluid should be maintained between 7 and 9. All further comparisons of nanofluids with different particle shapes were conducted at the same pH.

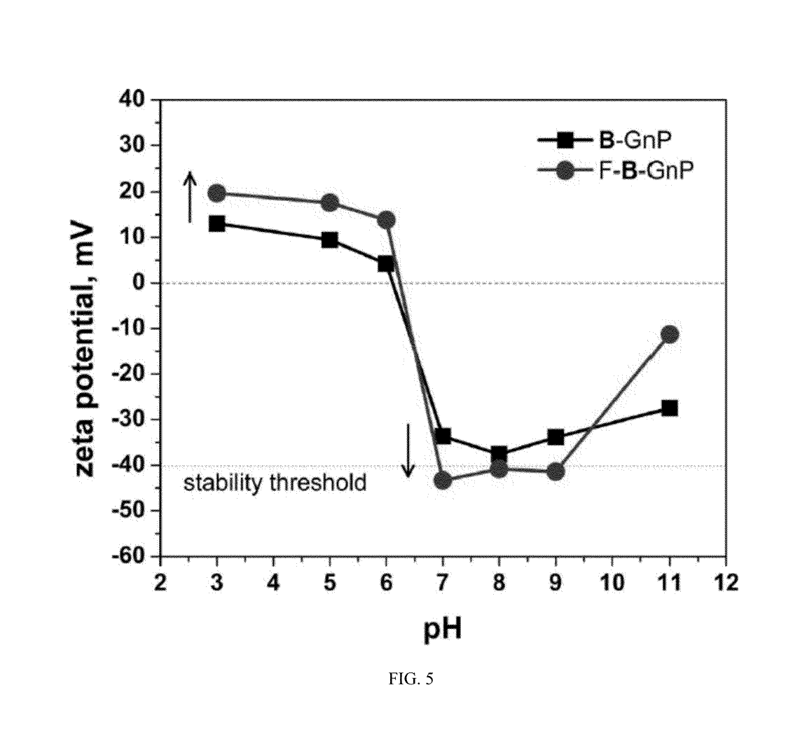

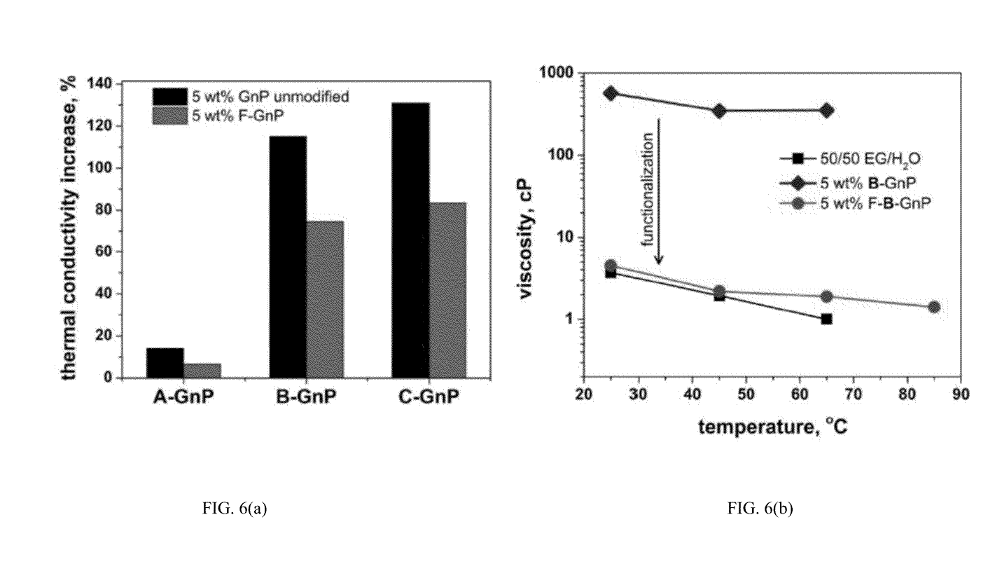

The effect of GnP surface functionalization of the thermo-physical properties of nanofluids were compared for unmodified GnP and f-GnP at 5 wt. % loadings (˜2.25 vol. %). Thermal conductivity enhancements measured in different grades of GnP and f-GnP nanofluids are illustrated in FIG. 6a. One can see that the highest increases in thermal conductivity were achieved in H5 grade, followed by M-5 grade, while C-750 grade provided the smallest increase in thermal conductivity. Surface functionalization of graphitic nanoparticles reduces the thermal conductivity enhancements in all grades by 30-50% of the analogous GnP suspensions. But still the increases in thermal conductivity are much higher than the prediction of effective medium theory (˜7%) reaching 75-85% above the base fluid at ˜2.25 vol. %. These results could be due to several reasons and without limiting the scope of the invention this will be considered hereinafter.

The effect of surface modification on viscosity of nanofluids is demonstrated on FIG. 6b comparing 5 wt. % nanofluids of unmodified GnP and f-GnP dispersed in EG/H₂O. Viscosity of f-GnP is nearly two orders of magnitude less that viscosity of the same grade of unmodified GnP. The viscosity of f-GnP nanofluid is only ˜30% higher than the viscosity of base fluid, which is very promising for heat transfer since it still provides a significant increase in thermal conductivity. It should be mentioned here that M-5 grade had the most dramatic drop in viscosity amongst all three grades. Without limiting the scope of the invention, the possible reasons for such effect will be discussed hereinafter.

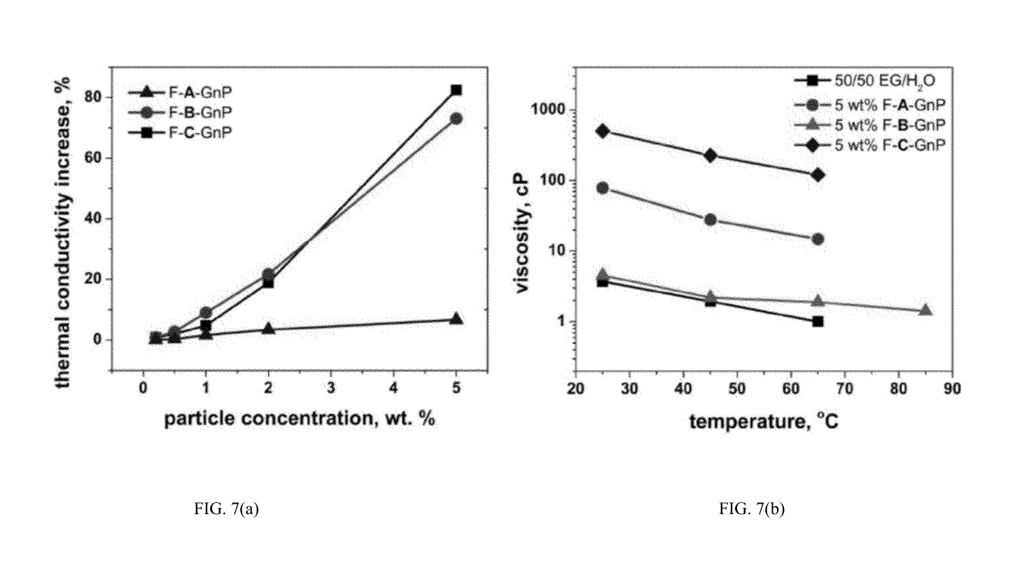

Thermal conductivity of f-GnP nanofluids with different particle morphologies was measured as a function of particle concentrations (see FIG. 7a). Particles with the smallest diameters and thicknesses (C-750 grade) show the smallest increase in thermal conductivity, closely following the prediction of the effective medium theory (˜3% increase in thermal conductivity per 1 vol % of nanoparticles added). Without limiting the invention, this indicates either that no percolation paths are formed in this nanofluid, or high surface area of graphite oxide prevents effective thermal conduction through such percolation networks. M-5 and H-5 grades show different behavior, providing much higher thermal conductivity increases at higher particle concentrations. This agrees with the proposed percolation heat transfer mechanism for anisotropic carbon nanomaterials. H-5 grade shows a slightly lower enhancement than M-5 at lower concentrations and slightly higher enhancements at higher particle concentrations. Without limiting the scope of the invention, these results can be interpreted as an effect of different particle morphologies. For thinner M-5 particles there are larger numbers of particles for the same concentration; thus, percolation threshold can be achieved at lower concentration then in H-5 grade. However, once a percolation threshold is achieved, the efficiency of thermal conduction is better in thicker, larger diameter particles as compared to a network of smaller diameters and thinner M5 nanoparticles. Smaller particle diameter/thickness of M-5 grade creates more interfaces, increases contributions of interfacial thermal resistance and thus less efficient thermal pathways.

Viscosity of f-GnPs with different morphologies are compared in FIGS. 7b for five different wt. % concentrations. One can see that despite similar functionalization treatment, and pH adjusted to 8.5±0.5, viscosity of f-GnP nanofluids varies significantly with the particle morphology. The lowest viscosity is observed in a nanofluid of M-5 grade, and it is only 20-30% higher than viscosity of the base fluid. In fact at 65° C. viscosity of this nanofluid is close to the lower limit of viscosities that can be measured with rotational spindle viscometer. Viscosity of H-5 grade changed insignificantly from surface functionalization from ˜600cP down to 500cP at 25° C. For the C-750 grade, f-GnP suspensions actually showed higher viscosity than the same concentration of unmodified GnPs in EG/H₂O. Without limiting the invention, this is most likely due to dense granular agglomerates of unmodified GnPs versus individual platelets of f-GnP as observed with SEM. Broken apart during functionalization C-750 flakes represent significantly higher area of solid/liquid interface than in granules, and thus is achieved an increased effective volume fraction, resistance to fluid flow and viscosity of f-GnP nanofluids. More details on how nanoparticle morphology affects the viscosity of nanoparticles will be presented hereinafter. At the same time stability of nanoparticle suspension was noticeably improved in all GnP grades.

The increase in thermal conductivity of f-GnPs was found to be temperature dependent, e.g. 5 wt. % M-5 fGnP showed ˜75% enhancement in thermal conductivity at 21° C. and ˜90% at 65° C. over the thermal conductivity of the base fluid at corresponding temperatures, indicating that even higher heat transfer enhancements are possible at elevated temperatures. The increase in thermal conductivity with temperature is expected for disordered materials, where the heat conduction mechanism is the hopping of localized excitations.

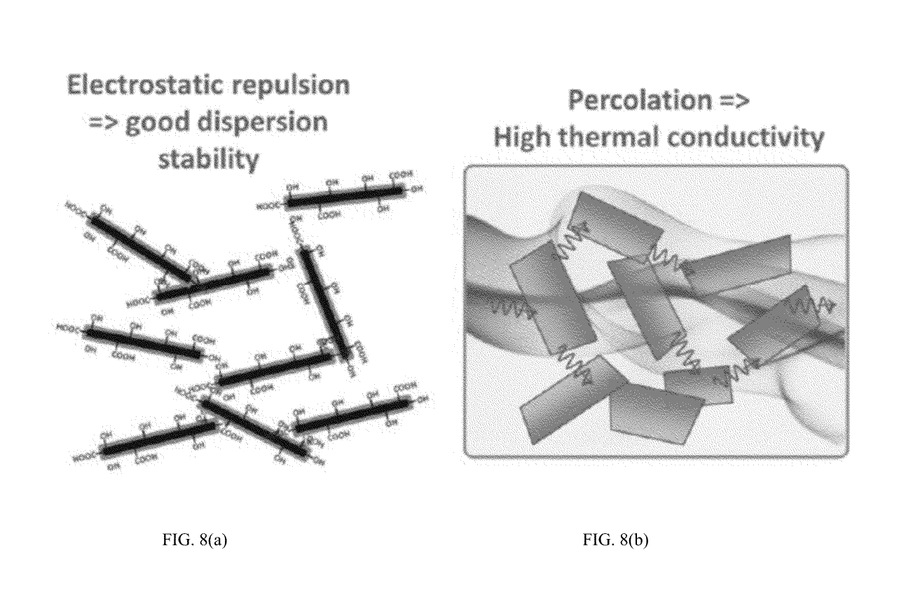

Without limiting the scope of the invention surface functionalization is believed to convert oxidized sp² graphitic layers into a variety of hydroxy- and carboxylic ionic groups. These groups can carry electrostatic charge and are miscible with water based fluids. Thus, core-shell structures of graphitic gore and graphene oxide shell are formed. (See FIG. 8a). On one hand, surface oxidation helps increasing the stability and decreasing viscosity of nanofluids; but, on the other hand, thermal conductivity of graphene oxides is much smaller than that of graphite and graphene. Therefore, the functionalization process decreases enhancements in thermal conductivity due to formation of surface oxides.

In development of nanofluids for heat transfer a fine balance needs to be obtained between increases in thermal conductivity and viscosity. For graphitic nanoparticle suspensions, advanced thermal conductivity is observed when nanoparticle percolation threshold is achieved. The concentration of the percolation threshold will vary with particle morphology, and both platelet diameter and thickness are important for that matter. Besides the important role of surface charges in nanoparticle agglomeration and viscosity of nanofluids, particle shape effect can also play a role in abnormally increased viscosity of graphitic nanofluids. Shear rate dependence of viscosity in suspensions indicates some restriction in fluid movement due to particle alignment and/or agglomeration. In a steady state, a rod-like particle or elongated agglomerate can have two types of motion due to the Brownian movements: rotational (end-over-end) motion around the mid-point, and translational motion in parallel or perpendicular to the long axis. When the average spacing between particles is much larger than the longest dimension of the particle, the rotational and translational motions are not restricted by each other; hence very weak shear thinning behavior is expected. In suspension of GnP nanoplatelets (aspect ratio p=7; defined as p=L/d, where L and d are the length (˜6.5 micron) and width (˜1 micron) of the platelets) free motion of particles is possible when the number density (c) is between 0 and 1/L³ that corresponds to the volume fraction between 0 and 1/p² (0<φ<0.023). In suspensions of cylinders with higher volume fractions (>2.3%) nanoparticles start to interact, so the viscosities at zero shear rate can be much greater than the base fluid viscosity and be very sensitive to the shear. At concentrations of nanomaterials that are significantly above the percolation threshold, an extended microstructure will be created in a nanofluid, obstructing the fluid flow and producing high viscosities.

Without limiting the scope of the invention, an efficient nanofluid for heat transfer is obtained by adjusting nanoparticle concentration for a given morphology of nanoparticles to reach the percolation threshold, but to minimize the obstruction to fluid flow. (See FIG. 8b). In one embodiment, such a balance was achieved with an M-5 grade of functionalized GnPs. It is also reasonable that a concentration of H-5 grade nanoparticles can be adjusted to meet percolation threshold without such a high viscosity increase. However larger particle sizes and thicknesses will likely result in a faster settling of nanoparticles, with all other parameters being the same.

Since the cooling efficiency of the heat transfer fluids is the main consideration in the current nanofluid development, the ratio of heat transfer coefficients for the suspensions and the base fluid was estimated for fully developed (hydrodynamically and thermally), laminar and turbulent flow regimes using conventional fluid dynamic equations. The ratio of heat transfer coefficients is a convenient measure for comparison of two fluids flowing in the same geometry and at the same flow rates. In a laminar flow regime, the heat transfer coefficients are proportional to the thermal conductivity (within the acceptable range of inlet/outlet temperature difference), but in a turbulent flow regime the heat transfer coefficients depend on a set of thermo-physical properties. Introduction of nanoparticles to the fluids changes density (ρ), thermal conductivity (k) viscosity (μ), and specific heat (Cp) of the coolant. In the case of hydrodynamically and thermally fully developed laminar flow, the heat transfer coefficient (h) is proportional to the thermal conductivity (k), and within the acceptable range of inlet/outlet temperature difference is independent of the flow velocity:

$$\frac{{h}_{nf}}{{h}_{0}} \approx \frac{{k}_{nf}}{{k}_{0}}$$

The comparison of two liquid coolants flowing in fully developed turbulent flow regime over or through a given geometry at a fixed velocity reduces to the ratio of changes in the thermo-physical properties:

$$\frac{{h}_{nf}}{{h}_{0}} \approx {( \frac{{ρ}_{nf}}{{ρ}_{0}} )}^{4 / 5} {( \frac{{c}_{{p}_{nf}}}{{c}_{{p}_{0}}} )}^{2 / 5} {( \frac{{μ}_{nf}}{{μ}_{0}} )}^{- 2 / 5} {( \frac{{k}_{nf}}{{k}_{0}} )}^{3 / 5} .$$

The nanofluid is beneficial when h_{nf}/h₀ ratio is above one and not beneficial when it is below one.

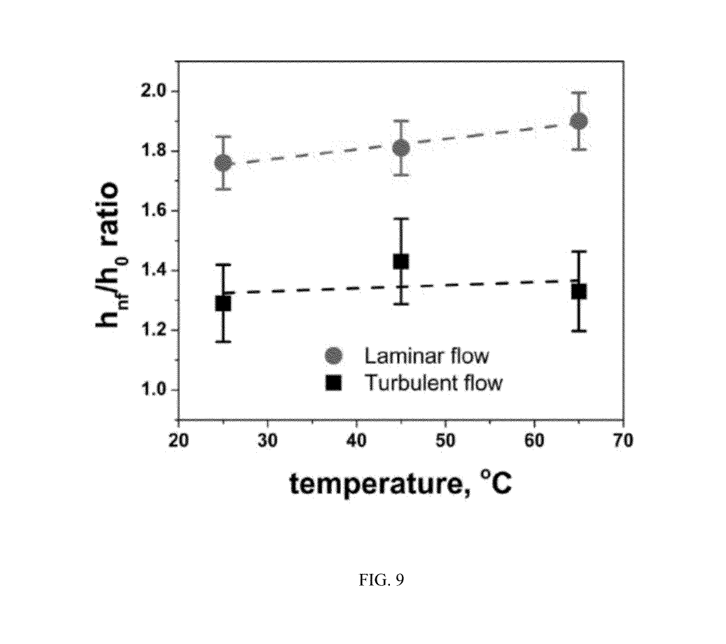

Experimental values for thermal conductivity and viscosity (density and specific heat were calculated from the rule of mixtures) were used for evaluation of heat transfer benefits of nanofluid with 5 wt. % of M-5 grade f-GnPs (See FIG. 9). The ratio of heat transfer coefficients (h_{nf}/h₀) for the nanofluid (h_{nf}) and the base fluid (h₀), calculated for different temperatures, shows that the inclusion of graphitic nanoparticles in EG/H2O coolant can provide significant 75-90% improvement in heat transfer rates when used in laminar flow regime, improving with increase in temperature. Heat transfer coefficients in the turbulent flow regime show 30-40% improvement in heat transfer compared to the base fluid. Previously it was observed that the heat transfer coefficient improves with temperature for nanofluids in both water based and organic base fluids. These results are very advantageous, since the enhancements levels not only meet the power electronics cooling criteria, but also will be beneficial in thermal management in medical, transportation, military, and many other applications.

Morphology and surface functionalization of graphitic nanoparticles have been developed for advantageous, improved thermo-physical properties and heat transfer performance of nanofluids in EG/H2O base fluid. Suspensions with larger diameter and thickness of nanoparticles provide the highest increase in thermal conductivity ˜130% at 5 wt %; however, viscosity increase of ˜100 times makes this fluid impractical for heat transfer applications. The optimization of viscosity and thermal conductivity increases in nanofluids is required for development of practical nanofluid with advanced heat transfer.

Surface functionalization of GnP powders created core/shell graphite/graphene oxide nanoplatelets that form stable suspensions in water based fluids. The optimization of nanoparticle surface chemistry and selection of particle morphology allowed producing nanofluid that meets the property criteria for efficient power electronics coolant, as well as other applications requiring such advantageous properties.

Such enhancements are possible with graphitic nanoparticles that are commercially available at reasonable costs. Graphitic nanofluids in a 50/50 mixture of ethylene glycol and water showed morphology dependent thermal conductivity; thermal conductivity ratio between 1.5 and 2.3 at 5 wt. % (room temperature) have been demonstrated, indicating the possibilities for dramatic improvement in power electronics cooling. Surface chemistry/functionalization provides better dispersion stability, lower viscosity, and higher thermal conductivity, enhanced performance with temperature.

An efficient nanofluid for heat transfer can include adjusting nanoparticle concentration for given morphology of nanoparticles to reach the percolation threshold, but to minimize the obstruction to fluid flow. A balance was achieved with an example M-5 grade of functionalized GnPs. Simple, low cost, and up-scalable surface modification methods are quite achievable for graphitic nanoparticles formulated in accordance with the invention; and the nanofluid coolant was obtained with an advanced combination of properties that allows 75+% improvement in heat transfer coefficient when used in laminar flow and 30+% enhancements in heat transfer coefficient when used in turbulent flow. The implementation of this technology in HEV's and EV's will result in reducing the size, weight and number of heat exchangers, further improving vehicle efficiency and fuel economy.

The following non-limiting Examples illustrate various aspects of the invention.

### EXAMPLE I

In order to carry out functionalization in one method for example, a 3:1 mixture of concentrated sulfuric and nitric acids (obtained from Fisher Scientific) of volume 50 ml of the acid mixture was added to (6 g) of GnP nanoparticles and stirred with a Teflon coated magnetic bar to achieve a homogeneous mix. The suspension of GnPs in acid mixture was sonicated in water bath five times ˜30 minutes in each sonication. Between the sonications magnetic stirring was applied. The length of acidic treatment was varied from few days to two weeks, and the effects of treatment duration on the thermo-physical properties of resulting nanofluids were studied.

Nanoparticles were washed with DI water in multiple cycles of centrifuging, decanting and re-dispersing of nanoparticles in DI water until pH of the suspension was above 3. Functionalized GnP (f-GnP) nanoparticles were further separated from water solution by centrifuging and dried in the oven at ˜60° C.

Nanofluid preparation: Dried f-GnPs nanopowders were used to prepare nanofluids with different concentrations. Weighted amount of nanopowders (1, 2, and 5 wt. %) was mixed into 50/50 by volume EG/H₂O base fluid. The mixture was homogenized by continuous stirring with a magnetic bar and sonicated 10 times (˜80W output power, 50% duty cycle, Branson Sonifier S-450) for five minutes each time. The pH of nanofluids was measured with a pH meter (ExStik PH100, ExTech Instruments). The pH of nanofluids was adjusted with 2N solution of ammonium hydroxide (NH₄OH, Fisher Scientific) in EG/H₂O or 2N solution of nitric acid in EG/H₂O (HNO₃, Fisher Scientific). After pH adjustments, suspensions were sonicated and equilibrated for ˜24 hours prior to further characterization.

### EXAMPLE II

Electron Microscopy: Scanning Electron Microscope (SEM) images of the nanopowders used were taken using a Hitachi S-4700. Samples for SEM were prepared by placing a droplet of diluted (˜0.001%) suspension of graphitic nanoparticles in ethanol (200Proof, Acros Organics) onto the silicon wafer and evaporating the solvent.

Particle sizes and Zeta Potential: The average particle sizes and zeta potentials in suspension were estimated by dynamic light scattering technique at a 90° scattering angle using a 90Plus/BIMAS particle size analyzer (Brookhaven Instruments Corp., NY). All samples were diluted ˜100÷1000 times to avoid multiple scattering effects.

Raman Spectroscopy: Raman spectroscopy of dried graphitic nanoparticles before and after surface modification was conducted at room temperature with 633 nm laser excitation on Raman Microscope (Renishaw, UK). Samples for Raman Spectroscopy were prepared by placing a droplet of nanoparticle suspension in water onto the sample glass and allowing solvent to evaporate.

Thermal Conductivity: The effective thermal conductivity of nanoparticle suspensions was measured using the transient hot wire based thermal property analyzer (Model KD2pro, Decagon Devices, Inc.). The reported values represent the average of at least 20 measurements.

Viscosity: The dynamic viscosity of nanofluids was measured between 25-65° C. using a Brookfield DV-II+ rotational type viscometer (Brookfield Engineering Laboratories, Inc.) with the SC4-18 spindle (instrument error ˜2%).

The foregoing description of embodiments of the present invention has been presented for purposes of illustration and description. It is not intended to be exhaustive or to limit the present invention for the precise form disclosed, and modifications and variations are possible in light of the above teachings or may be acquired from practice of the present invention. The embodiments were chose and described in order to explain the principles of the present invention and this practical application to enable one skilled in the art to utilize the present invention in various embodiments, and with various modifications, as are suite to the particular use contemplated.

What is claimed is:

1. A heat transfer fluid, comprising
a fluid medium; and
an oxidized form of material selected from the group of multilayer graphene nanoplatelets.

2. The heat transfer fluid as defined in claim 1 wherein fluid medium is polar.

3. The heat transfer fluid as defined in claim 2 wherein the polar fluid medium is selected from the group of ethylene glycol and water, propylene glycol and water, glycerin and water and mixtures thereof.

4. The heat transfer fluid as defined in claim 1 wherein there is no surfactant present in the fluid medium.

5. The heat transfer fluid as defined in claim 1 wherein the heat transfer fluid containing the oxidized form of the multilayered graphene nanoplatelets has an increase of thermal conductivity over base fluid of about 85% and increase viscosity of ˜only 30%.

6. The heat transfer fluid as defined in claim 1 wherein the heat transfer fluid containing an oxidized form of multilayered graphene nanoplatelets has a heat transfer coefficient ratio as compared to the base fluid between 1.75 and 1.90 for laminar flow and 1.3-1.4 for turbulent flow in the temperature range 25-65° C.

7. The heat transfer fluid as defined in claim 1 wherein the oxidized form of the multilayered graphene nanoplatelets have OH⁻, COO⁻ and CO groups in place of surface sp² graphitic layers for the multilayered graphene nanoplatelets.

8. The heat transfer fluid as defined in claim 1 wherein the oxidized form of the multilayered graphene nanoplatelets has a morphology of dispersed unagglomerated nanoplatelets.

9. The heat transfer fluid as defined in claim 1 wherein the oxidized multilayered graphene nanoplatelets have an electrostatic charge on platelets of the multilayered graphene nanoplatelets, thereby keeping the nanoplatelets separated from one another and in suspension in the fluid medium.

10. The heat transfer fluid as defined in claim 1 wherein the fluid medium is a non-polar fluid medium selected from the group consisting of synthetic oil, poly-alpha-olefins or paraffin base fluid.

11. The heat transfer fluid as defined in claim 1 wherein the functionalized multilayer graphene nanoplatelets have a particle structure of a graphitic core and a graphene oxide shell.

12. The heat transfer fluid as defined in claim 1 wherein the multilayered graphene nanoplatelets have a defect structure characterized by a Raman shoulder at about 1620 cm ⁻¹ proportional to the surface area versus volume of nanoplatelets.

13. The heat transfer fluid as defined in claim 1 wherein the Zeta potential of the heat transfer fluid is more than about 40 mV for a pH between about 7-9, thereby providing good suspension stability.

14. A method of manufacturing a heat transfer fluid, comprising the steps of:
providing a raw material of multilayered graphene nanoplatelets;
oxidizing the graphene nanoplatelets;
providing a fluid medium selected from a polar medium and a non-polar medium;
adjusting the particle concentration for the morphology of nanoplatelets including thickness and diameter to achieve percolation threshold for a high thermal conductivity and low viscosity; and
mixing the multilayered graphene nanoplatelets and the fluid medium.

15. The method as defined in claim 14 wherein the step of oxidizing the multilayered graphene nanoplatelets comprises disposing as received multilayered graphene nanoplatelets in an acid.

16. The method as defined in claim 15 wherein the acid comprises a mixture of sulfuric and nitric acid.

17. The method as defined in claim 14 wherein the polar fluid medium is selected from the group of water, ethylene glycol, propylene glycol, glycerin, oil and mixtures thereof.

18. The method as defined in claim 14 wherein the heat transfer fluid in polar fluids does not include a surfactant and pH is adjusted/buffered for maximum value of zeta potential to pH 7-9.

19. The method as defined in claim 14 wherein the step of oxidizing includes forming a graphene oxide shell on a graphitic core.

20. The method as defined in claim 14 further including estimation of optimal nanoplatelet concentration from the particle geometry to achieve maximum heat transfer benefits for both polar and non-polar fluid media.
